(19) United States
(12) Patent Application Publication
(10) Pub. No.: US 2015/0019626 A1
(43) Pub. Date: Jan. 15, 2015

(54) SERVER DEVICE, CLIENT MACHINE, AND CONTENT PLAYBACK PROGRAM

(71) Applicant: Funai Electric Co., Ltd., Osaka (JP)

(72) Inventor: Junya SENOO, Daito-shi (JP)

(21) Appl. No.: 14/321,962

(22) Filed: Jul. 2, 2014

(30) Foreign Application Priority Data
Jul. 10, 2013 (JP) 2013-144472

(51) Int. Cl. H04L 29/08; G06F 3/0484; H04L 29/06

(52) U.S. Cl. CPC H04L 67/10; H04L 65/403; G06F 3/0484; H04L 67/42
USPC 709/203

(57) ABSTRACT

A server device includes a controller configured and programmed to register, when a playback-capable notice notifying that content can be played on a client machine is acquired from the client machine, the client machine that sent the playback-capable notice as a content transmission destination in a storage device and which transmits the content to the registered client machine, and a client machine which plays back the content sent from the server device.

### BACKGROUND OF THE INVENTION

1. Field of the Invention

The present invention relates to a server device that transmits content within the server device to a client machine desired by an operator, a client machine that plays back the content transmitted from the server device, and a content playback program that plays the content on the server device on a client machine.

2. Description of the Related Art

In recent years, the number of networks (LANs) that connect information-technology appliances such as television receivers, disc recording and playback devices, smartphones, and tablet PCs has increased. Home network systems equipped with this sort of network are able to send content such as music, images, and movies stored on a single connected machine to other machines and play it. Doing so enables an operator to play content on information-technology appliances connected to the network without using media on which the content is recorded (memory cards, optical disk, and the like) and therefore increases convenience.

Such network systems that transmit and play content include systems such as that described in Japanese Patent Application Laid-Open Publication No. 2008-310451, for example. In the home network system described in Japanese Patent Application Laid-Open Publication No. 2008-310451, a television, an HDD recording and playback machine, and a personal computer are connected. In the home network system, furthermore, the television is used as a digital media player (DMP) that plays back content. Moreover, the HDD recording and playback machine and the personal computer are used as digital media servers (DMS) that provide content.

In addition, the DMS is constituted so as to provide (transmit) content information to the DMP in response to requests for content information from the DMP. The use of such a network system makes it possible for an operator to operate the DMP to play, on the DMP, content stored on the DMS physically separated from the DMP.

With the configuration of Japanese Patent Application Laid-Open Publication No. 2008-310451, however, when using a digital media renderer (DMR), which cannot accept operating input, such as speakers and monitors, requesting content is impossible, so it is difficult to play back content on the DMR.

When a DMR is selected as such a machine that operates the content, a DMR that plays back content can be selected using a controller or DMS connected to a home network system. However, in home network systems in which a plurality of DMRs are connected, the desired DMR must be selected from a list of connected equipment, and it can be difficult sometimes to know which is the desired DMR. Because the home network system is built using IP, for example, it is difficult to calculate the distance between the operator and the DMR, and the like, so it may sometimes be difficult to select the DMR located right in front of the operator.

### SUMMARY OF THE INVENTION

Accordingly, preferred embodiments of the present invention provide a server device that transmits content within the server device to a client machine desired by an operator by a simple operation and a client machine that plays back content sent from the server device.

Furthermore, other preferred embodiments of the present invention provide a content playback program configured to play back content stored within a server device on a client machine desired by an operator.

A server device according to a preferred embodiment of the present invention is a server device which plays back, on a client machine connected to the same local network, content that it holds, wherein the server device includes an operation input unit configured to accept input from an operator; and a controller configured and programmed to register, when a playback-capable notice notifying that content can be played back on the client machine is acquired from the client machine, the client machine that sent the playback-capable notice as a content transmission destination in the server device and then transmit content to the registered client machine.

A server device according to a preferred embodiment of the present invention is configured to enable content to be transmitted to and played on a client machine that the operator requests without the operator performing any particular operation on the client machine to which the content is transmitted.

This allows the desired client machine to be easily identified and content to be played on this client machine even when it is difficult for the operator to identify the client machine from a list of client machines connected to the local network.

The controller preferably is configured and programmed so as to register the client machine that transmitted the playback-capable notice as a content transmission destination only when the operator has enabled the client machine that transmitted the playback-capable notice. By using such a configuration, there is no need to search for the client machine again when the server device is disconnected from the local network and then re-connected to the local network.

The controller preferably is configured and programmed so as to search for the client machine to which content is to be transmitted when the operator selects content through the operation input unit. With such a configuration, the operator performs playback on a client machine simply by playing content.

The controller preferably is configured and programmed to transmit content to the client machine when enabling operating input occurs at the operation input unit. The use of such a configuration makes it possible to inhibit transmission of content to a client machine that the operator does not intend.

A playback unit preferably is provided and configured to play the content, and the controller preferably is configured and programmed to pause the content being played if the playback-capable notice is acquired while the content is being played and also so as to transmit the portion after the paused portion of the content that was being played to the registered client machine only when there is the registered client machine. With such a configuration, the operator is capable of playing content on a client machine in a state in which the content is being played on a server device while also maintaining this playback state.

When halt information that halts playback of the content is acquired from the registered client machine, the controller preferably erases the client machine registration and also stops content transmission. With such a configuration, when content transmission to the client machine is restarted by the server device, transmission of content to the previously registered client machine is prevented. This makes it possible to inhibit playback of content on a client machine that the operator does not intend.

The controller preferably is configured and programmed such that when the halt information is acquired, it plays back the continuation of the content on the playback unit from the stopped position. By using such a configuration, the operator is able to continue watching or listening to content so long as the operator moves within the service area of the local network while carrying the server device 1.

The server device according to a preferred embodiment of the present invention described above preferably is configured such that the halted state of content transmission is maintained until machine information from a client machine that can play the content is transmitted. With such a configuration, it is possible to determine the content to be played in advance and to subsequently determine the client machine that will play the content.

A client machine according to another preferred embodiment of the present invention is a client machine connected to a local network and configured to play content transmitted from a server device, wherein the client machine includes an information transmission unit configured to transmit the playback-capable notice to the server device. With such a configuration, it is possible to have the server device accurately confirm the client machine operated by the user. This saves the operator the task of selecting a client machine.

The information transmission unit preferably is configured so as to transmit the playback-capable notice as soon as the power to the client machine is turned on. By having such a configuration, the playback-capable notice is transmitted by the simple and always-performed operation of turning the power on, which can save a task for the operator.

According to another preferred embodiment of the present invention, a non-transitory computer-readable medium includes a computer program for performing, when the computer program runs on a computer, a method including registering a client machine connected to a same local network when a playback-capable notice notifying that content stored on a server device is capable of being played back on the client machine is acquired from the client machine; registering the client machine that sent the playback-capable notice as a content transmission destination; and transmitting the content to the registered client machine so that the client machine plays back the content.

Various preferred embodiments of the present invention make it possible to play back content held by a server on a client machine desired by an operator with a simple operation.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic diagram of a local network in which the server device and the client machines according to a preferred embodiment of the present invention are connected.

FIG. 2 is a block diagram showing the outline of the server device and one of the client machines according to a preferred embodiment of the present invention.

FIG. 3 is a flowchart showing one example of a procedure in which content held on the server device according to a preferred embodiment of the present invention is played on a client machine.

FIG. 4 is a flowchart showing another example of a procedure in which content held on the server device according to a preferred embodiment of the present invention is played on a client machine.

FIG. 5 is a flowchart showing yet another example of a procedure in which content held on the server device is played on a client machine.

FIG. 6 is a flowchart showing still another example of a procedure in which content held on the server device is played on a client machine.

### DETAILED DESCRIPTION OF THE PREFERRED EMBODIMENTS

Preferred embodiments of the present invention will be described below with reference to drawings.

### First Preferred Embodiment

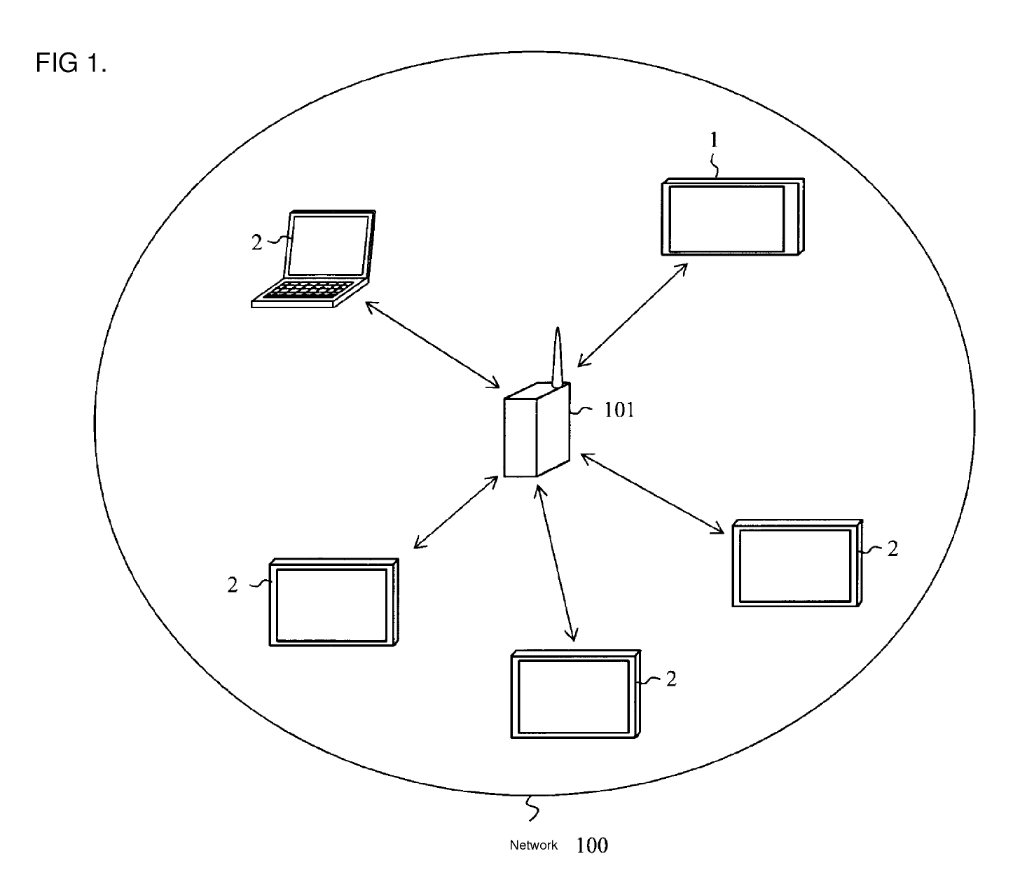

FIG. 1 is a schematic diagram of a local network in which the server device and the client machines according to a first preferred embodiment of the present invention are connected. As shown in FIG. 1, a local network 100 is provided with a server device 1 that acts as the content server and client machines 2 (such as a television and PC, for example) that are capable of content playback. In the following description, it is assumed that the server device 1 shown in FIG. 1 is a smartphone that holds playback content such as movies and music, while the client machines 2 are televisions capable of playing movies and music, for example.

Furthermore, the local network 100 shown in FIG. 1 is a conventional wireless local network such as a Wi-Fi (registered trademark) network. To explain further, the local network 100 is a local network with a wireless LAN base unit 101 as its hub to which electronic equipment that is able to connect wirelessly within a household is connected to allow bidirectional communication.

Moreover, the server device 1 and client machines 2 that are connected to the local network 100 are compatible with the guidelines formulated by the Digital Living Network Alliance (DLNA, registered trademark), or DLNA Guidelines. Equipment that is compatible with these DLNA Guidelines can easily be connected to the local network and exchange information between machines connected to the local network.

For example, a smartphone constituting the server device 1 automatically connects to the local network 100 by receiving the electromagnetic waves of the wireless LAN in a state in which wireless LAN connection is enabled. In addition, the client machines 2 are constituted so as to connect to the local network as soon as they are turned on.

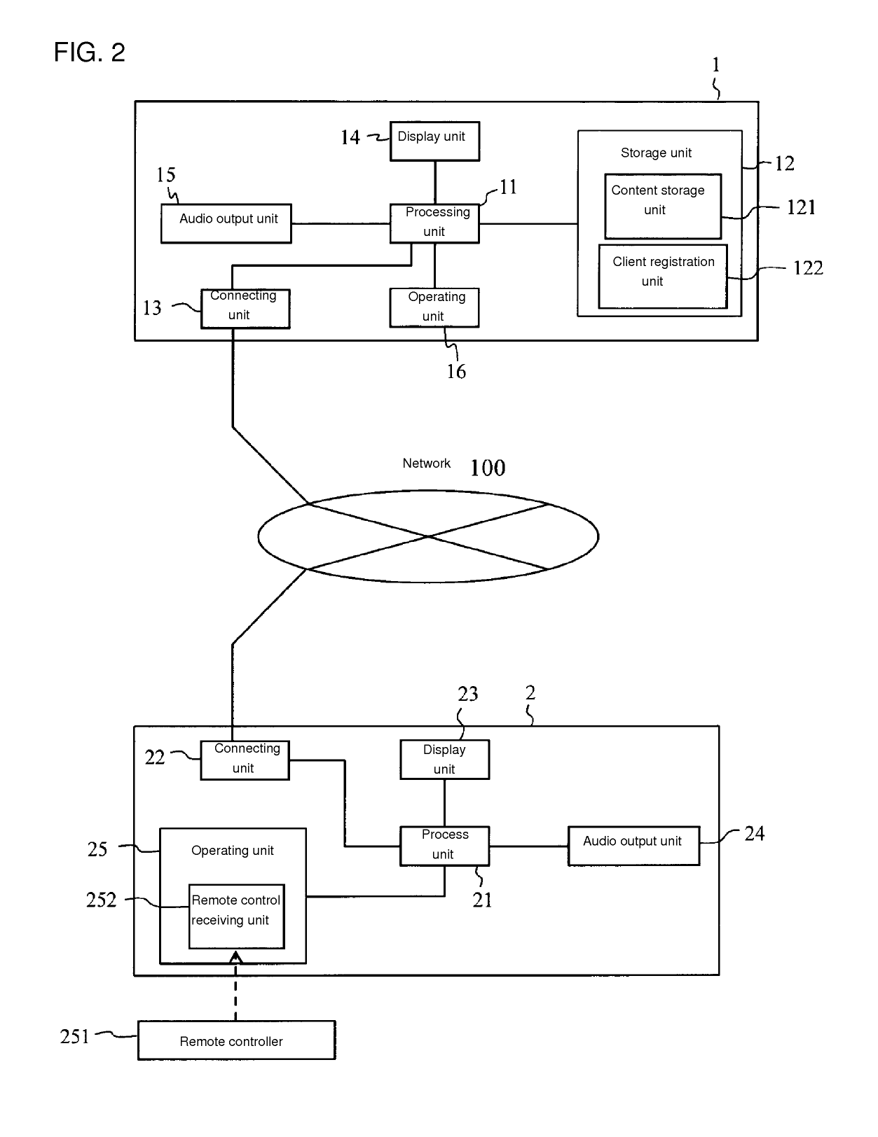

FIG. 2 is a block diagram showing an outline of the server device and one of the client machines according to a preferred embodiment of the present invention. As shown in FIG. 2, the server device 1 is equipped with a processing unit 11 (controller), a storage unit 12, a connecting unit 13, a display unit 14, an audio output unit 15, and an operating unit 16 (operation input unit). Furthermore, the display unit 14 and the audio output unit 15 are examples of the playback unit.

The processing unit 11 is a control circuit configured to control the server device 1 while also being a processing circuit configured to process signals and information that are transmitted to it and that it transmits. The processing unit 11 is a circuit that includes logic circuitry (such as a microcomputer) configured and programmed to comprehensively control the connecting unit 13, the display unit 14, the operating unit 15, and the like.

The storage unit 12 is configured by being equipped with ROM (used for reading only) and RAM (which is readable and writable) which store various types of information used when exercising control with the processing unit 11 as well as information that has been processed, and elements such as nonvolatile memory which can hold information. Moreover, the configuration is not limited to this, and a wide variety of configurations provided with elements that are configured to store information can also be adopted.

In addition, the storage unit 12 preferably includes a content storage unit 121 configured to store content such as movies and sound and a client registration unit 122 that registers the information of client machines 2 to which content is transmitted. The client registration unit 122 stores client information based on information received from the client machines 2 according to instructions from the processing unit 11 when the client machines 2 are connected to the local network 100. Examples of client information include IP addresses, device types, names of machines, and the like.

The connecting unit 13 is a wireless connection interface configured to wirelessly connect to the local network 100. Furthermore, because the server device 1 is a smartphone, the connecting unit 13 connects to a mobile telephone connection network and is therefore configured so as to be able to send and receive the electromagnetic waves of a mobile telephone as well.

The connecting unit 13 has functions that receive the radio waves of the local network 100 and transmits the received radio waves to the processing unit 11. Moreover, the connecting unit 13 connects to the local network 100 according to instructions from the processing unit 11 when the processing unit 11 determines based on the information of received radio waves that it is a connectable local network.

The display unit 14 is configured to display still images, movies, and other video; here, the display unit 14 preferably is a liquid crystal display, for example. Note that the display unit 14 is not limited to a liquid crystal display, and a wide variety of display devices that can display video, such as organic ELs, can be used. The display unit 14 is configured to display content such as images and movies according to instructions from the processing unit 11 and display operating screens used to operate the server device 1.

The audio output unit 15 is configured to output audio according to sound information when content that includes sound information of movies, music, and the like is played back, and it is configured so as to include speakers. Note that speakers are cited as an example of the audio output unit 15, but it is also possible to use a configuration provided with headphone terminals only, or the audio output unit 15 may be omitted when the configuration of the server device 1 does not require audio output.

The operating unit 16 is a user interface configured to operate the server device 1. Here, the operating unit 16 preferably is a touch panel with which an operation associated with an operating image can be input by touching the operating image displayed on the display unit 14. However, the operating unit 16 is not limited to a touch panel and may be something which includes push buttons that can be physically operated.

Next, a client machine will be described with reference to the drawing. The client machine 2 is a television as described above, and the client machine 2 preferably includes a processing unit 21, a connecting unit 22, a display unit 23, an audio output unit 24, and an operating unit 25.

The processing unit 21 is a control circuit configured and programmed to control the client machine 2 while also being a processing circuit that processes signals and information that are transmitted to it and that it transmits. The processing unit 21 is a circuit that includes logic circuitry (such as a microcomputer) that comprehensively controls the connecting unit 22, the display unit 23, the operating unit 25, and the like.

The connecting unit 22 is a wireless connection interface configured to wirelessly connect to the local network 100. The wireless connection to the local network 100 is preferably started according to the instruction of the processing unit 21. Then, once the connection to the local network is established, the connecting unit 22 maintains the connection to the local network 100 as long as the power of the client machine 2 is on. Then, the client machine 2 can send and receive information through the connecting unit 22. The client machine 2 is configured to receive content from the server device 1 through the connecting unit 22. In addition, a playback-capable notice, which notifies that the client machine 2 is a machine capable of playback, is transmitted to the server device 1.

The display unit 23 is configured to display still images, movies, and other video. The display unit 23 preferably is a liquid crystal display, for example. Note that the display unit 23 is not limited to a liquid crystal display, and a wide variety of display devices that can display video, such as organic ELs, can be used. The display unit 23 is configured to play content transmitted from the server device 1. Furthermore, although a detailed description is omitted, the client machine 2 is configured to receive television broadcast waves and display television broadcasts. Note that television broadcasts are considered a type of content.

The audio output unit 24 is configured to output audio when playing content that includes sound or sound information. Here, a speaker is preferably an example of the audio output unit 24. Moreover, the audio output unit 24 may also be an interface configured to output audio information to the outside and may be configured be connectable to speakers or the like installed externally.

The operating unit 25 is a user interface configured to operate the client machine 2. The operating unit 25 is equipped with a remote controller 251 that accepts operations by an operator and a remote control receiving unit 252 that receives signals from the remote controller 251. Note that communications between the remote controller 251 and the remote control receiving unit 252 are performed by infrared rays, but the present invention is not limited to this.

In addition, when the remote control receiving unit 252 receives the operation that turns the power on using the remote controller 251, the processing unit 21 transmits a playback-capable notice to the local network 100 using the connecting unit 22 notifying that content can be played. Note that the playback-capable notice is transmitted when the power is turned on. Furthermore, in FIG. 2, the remote controller 251 is shown preferably as external to the client machine 2, but it is a device that accepts operating input from an operator, so a description will be given here as being part of the operating unit 25.

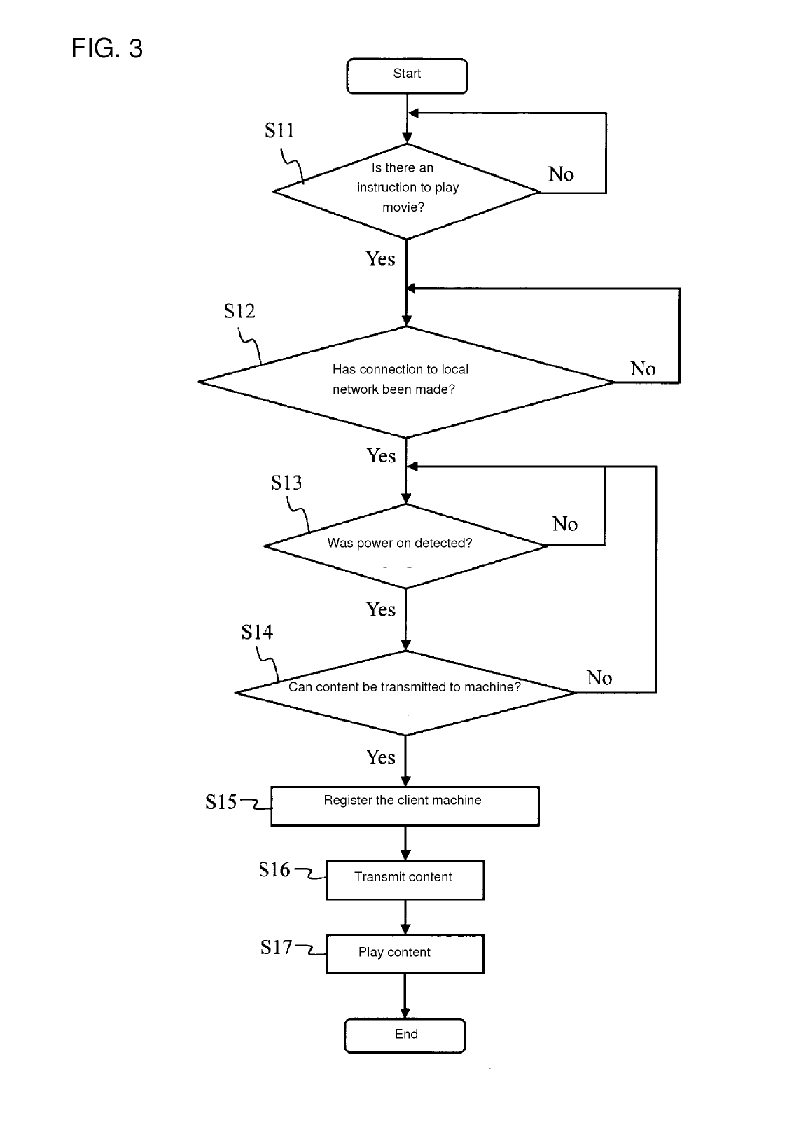

A content playback procedure that uses the server device 1 and the client machine 2 described above will be described with reference to figures. FIG. 3 is a flowchart showing one example of a procedure in which content held on the server device according to a preferred embodiment of the present invention is played on a client machine. Note that, in the discussion that follows, it is assumed that the content to be played is a movie, but the content is not limited to this; playback is performed by similar operations for photos (still pictures), music (sound), and the like as well. Moreover, the following actions of the server device 1 are assumed to be done with each component under the control of the processing unit 11; the processing unit 11 may be equipped with dedicated circuitry for control for each action, or each action may be provided as a control program run by the processing unit.

The server device 1 looks up whether or not the content (movie) playback instruction was input by the operator using the operating unit 16 (step S11). If no content playback instruction was input (No in step S11), it is waited until a content playback instruction is input (returns to step S11). Here, content playback instructions also include operations that select the content to be played back.

If the input of an instruction to play back content was detected (Yes in step S11), it is checked whether or not the server device 1 is connected to the local network 100 (step S12). If the server device 1 is not connected to the local network 100 (No in step S12), it is waited until the server device 1 is connected to the local network 100. Note that the order of detecting input of content playback instructions (step S11) and checking for connection to the local network 100 (step S12) may be reversed.

When the server device 1 is confirmed to be connected to the local network 100 (Yes in step S12), the server device 1 determines whether or not the power is turned on to the client machines 2 (step S13). The determination of whether or not power has been turned on to the client machines 2 is based on the ON signals (playback-capable notices) sent from the client machines 2. When the power has been turned on to the client machines 2 by operation of the remote controller 251, an ON signal (playback-capable notice) is transmitted to the local network 100. The server device 1 determines that a client machine 2 is on when it receives the signal via the connecting unit 13.

If no client machine 2 is on (No in step S13), the server device 1 waits until power to a client machine 2 is turned on (returns to step S13). In addition, if the server device 1 detects that power has been turned on to a client machine 2 (Yes in step S13), it determines whether or not the client machine that has been turned on is a machine to which content can be transmitted (step S14). If a client machine that is on is not a machine to which content can be transmitted (No in step S14), the detection of power being turned on to a client machine 2 resumes (return to step S13).

Note that a client machine 2 being a machine to which content can be transmitted refers to a machine that is able to play content. For example, if the content is a movie, the client machine 2 is at least equipped with devices configured to play back content (the display unit 23 and the audio output unit 24). Furthermore, besides this, there may be cases in which content transmission is restricted by the server device 1. In such cases, in addition to the conditions, the determination may also be based on whether or not the client machine 2 is a machine to which the server device 1 restricts (or enables) its content transmission.

If a client machine that is on is a machine to which content can be transmitted (Yes in step S14), the client machine 2 that was turned on is registered by the server device 1 in the client registration unit 122 as a client machine to which content can be transmitted (step S15).

The content to be played is then transmitted to the registered client machine 2 (step S16). The client machine 2 plays back the transmitted content on the display unit 23 and the audio output unit 24 (step S17).

Thus, content stored on the server device 1 can be transmitted to a client machine 2 connected via the same local network 100 and played back on the client machine 2.

Because of this, even if the client machine that will play content is a renderer (Digital Media Renderer, or DMR), which does not make a content playback request, content is still transmitted without the operator performing an operation to select a renderer. Specifically, by the simple operation of turning the power on to a client machine 2 without the operator performing an operation to specify the client machine 2, it is possible to transmit content to the desired client machine and also to play back the content. If such a configuration is used, it is possible to eliminate the task of the operator looking at a list of client machines 2 displayed on the server device 1 and selecting the desired client machine.

Moreover, the information of client machines connected on the local network includes text information such as IP addresses and machine names; the operator must be familiar with the information in order to select the correct client machine. Because the client machine to which the content is transmitted is set by the simple operation of turning the power on to a client machine 2 as in various preferred embodiments of the present invention, content is accurately transmitted to the desired client machine even with an operation by an inexperienced operator.

### Second Preferred Embodiment

In the playback action, content was transmitted to a client machine 2 that was freshly turned on. However, there may be client machines 2 that are already connected to the local network 100 before the client machine 2 is freshly turned on. Therefore, content playback by the server device 1 when client machines 2 are already connected to the local network 100 will be described making reference to figures.

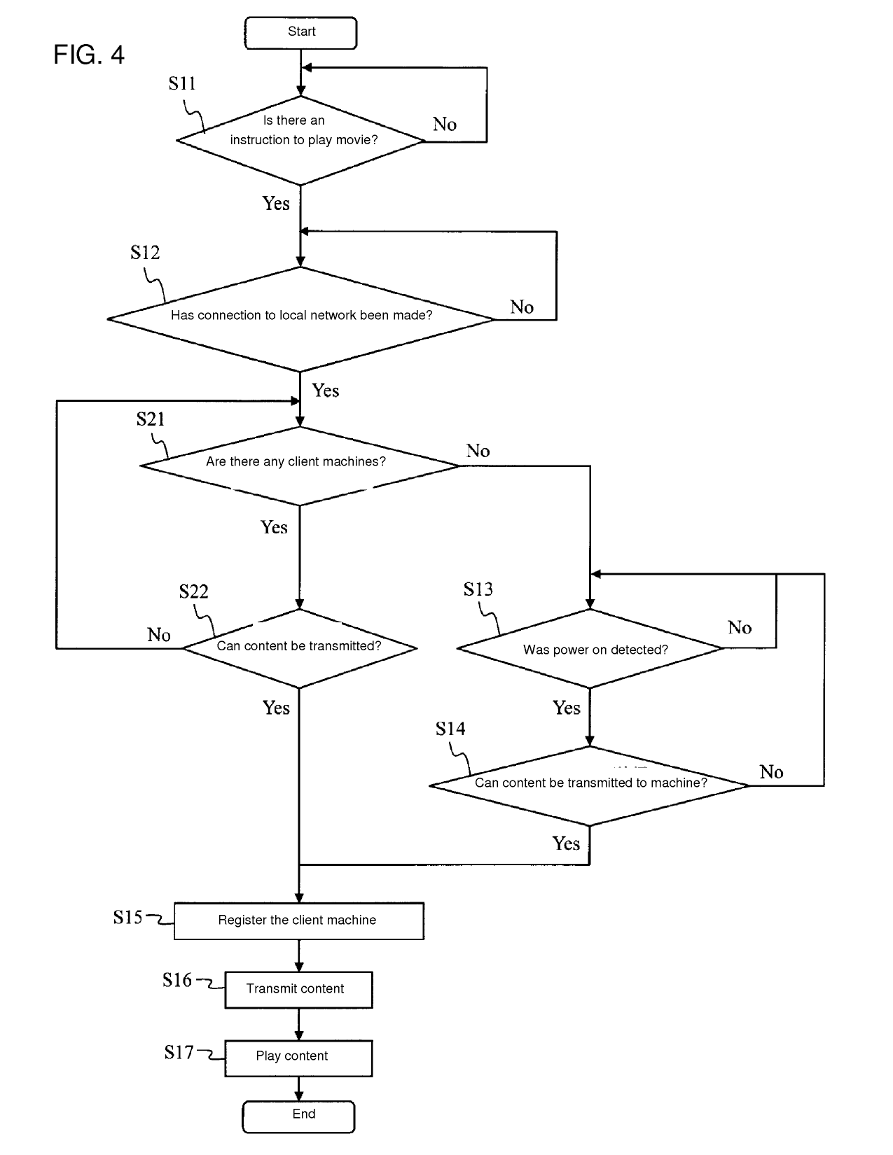

FIG. 4 is a flowchart showing another example of a procedure in which content held on the server device according to a preferred embodiment of the present invention is played on a client machine. Note that the configuration of the server device 1 and the client machine 2 is the same as the one shown in FIG. 2; the same symbols are assigned to the same elements, and the detailed description of the same elements will be omitted. In addition, the same symbols are assigned to the elements that are the same as those on the flowchart for the content playback procedure shown in FIG. 3, and the detailed description of the same elements will be omitted.

When the server device 1 is confirmed to be connected to the local network 100 (Yes in step S12), it searches to see whether or not there is a client machine 2 capable of playing content on the local network 100 (step S21). Note that client machines 2 are set up to send playback-capable notices when there is a predetermined operating input (such as a specified operation by the remote controller 251), and the server device 1 determines that a client machine is playback-capable when it receives a playback-capable notice.

If there is no client machine 2 capable of playing content on the local network 100 (No in step S21), the server device 1 determines whether or not a client machine 2 has been turned on (step S13). Thereafter, content playback is performed using the same procedure as in FIG. 3.

If the server device 1 finds a client machine 2 capable of playing content on the local network 100 (Yes in step S21), it checks whether or not it is OK to transmit content to the discovered client machine 2 (step S22). If it confirms input by the operator that content may be transmitted to the discovered client machine 2 (Yes in step S22), the server device registers the discovered client machine 2 in the client registration unit 122 (step S15). Thereafter, content playback is performed using the same procedure as in FIG. 3.

Furthermore, if it has confirmed input by the operator not to transmit content to the discovered client machine 2 (No in step S22), the server device 1 searches to see whether or not another client machine 2 is connected to the local network 100 (returns to step S21). Note that the operator input detected in step S22 is input performed by the operator on the operating unit 16 of the server device 1.

By making content playback execute as described above, the operator determines which client machines are able to play back content even when many client machines are already connected to the local network 100.

Note that in cases where the server device 1 receives a playback-capable notice as a result of the operator operating the operating unit 25 of a client machine 2 and thus determines that it is a playback-capable client machine, this client machine is the machine selected by the operator. For this reason, the confirmation by the operator that it is okay to transmit content (step S22) may be omitted.

### Third Preferred Embodiment

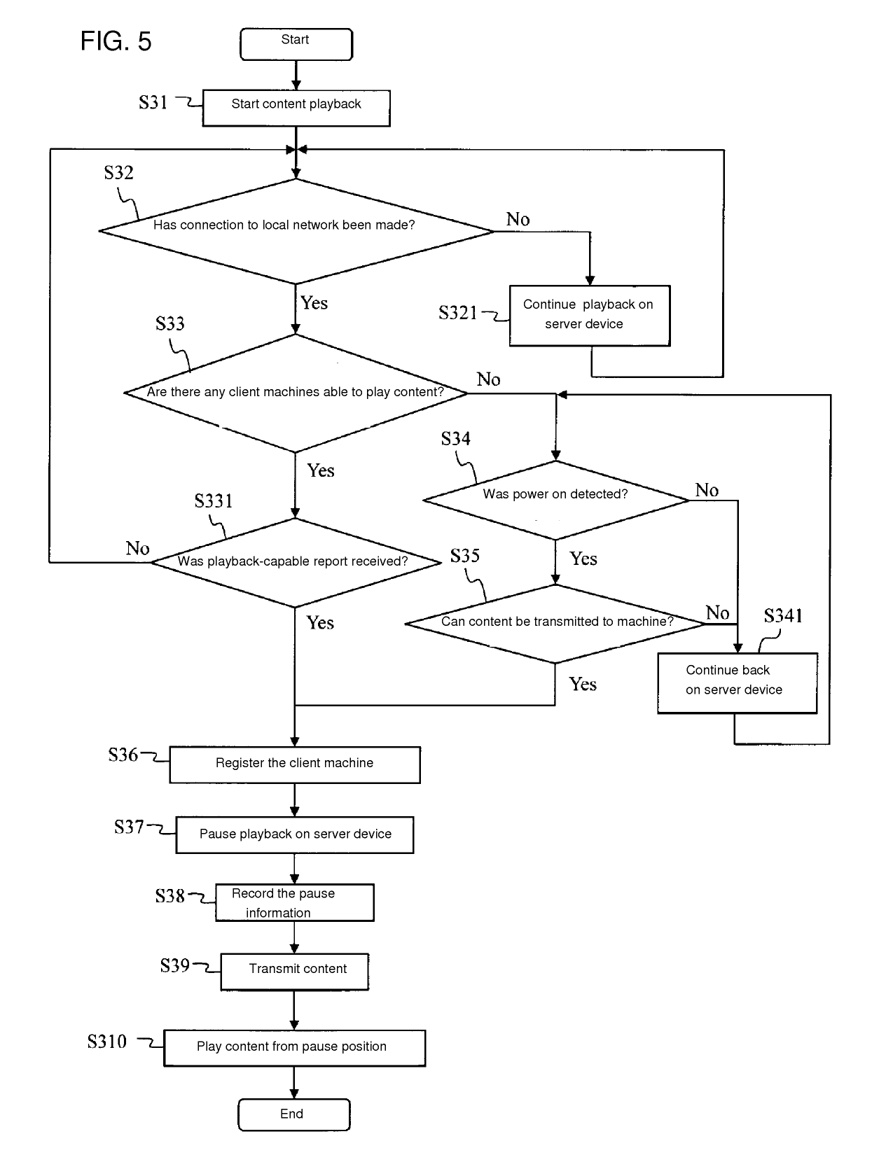

Yet another example of playback, on a client machine, of content held on the server device according to a preferred embodiment of the present invention will be described with reference to figures. FIG. 5 is a flowchart showing yet another example of a procedure in which content held on the server device is played on a client machine. Note that the server device and the client machine are the same as the ones shown in FIG. 2, so detailed descriptions will be omitted, and explanation will be given with the same symbols being assigned to elements that are essentially the same.

As was described above, the server device 1 preferably is a smartphone; the server device 1 is itself able to play back content (movies). Therefore, in the present preferred embodiment, a description will be given of the procedure for transmitting, to a client machine 2, content that is played back by the server device 1 while the content is being played back.

First, the server device 1 plays content (step S31). A playback step for the server device 1 is mentioned here in order to make this easier to understand, but the procedure may also be started in a state in which content is being played on the server device 1.

Then, it is checked whether or not the server device 1 is connected to the local network 100 (step S32). If the server device 1 is not connected to the local network 100 (No in step S32), playback is continued on the server device 1 (step S321), and the connection to the local network 100 is checked (return to step S32).

When the connection to the local network 100 is confirmed (Yes in step S32), the server device 1 searches to see whether or not there is a client machine 2 capable of playing content on the local network 100 (step S33). If there is no client machine 2 capable of playing content on the local network 100 (No in step S33), the server device 1 determines whether or not a client machine 2 has been turned on (step S34).

If the server device 1 cannot detect a client machine 2 that is on (No in step S34), the server device 1 continues to play the content (step S341) and waits until a client machine 2 is turned on (returns to step S34). Moreover, if the server device 1 detects that power has been turned on to a client machine 2 (Yes in step S34), it determines whether or not the client machine that has been turned on is a machine to which content can be transmitted (step S35). If content cannot be transmitted to the client machine that has been turned on (No in step S35), the server device 1 continues to play the content (step S341) and waits for power to be turned on to a client machine 2 (returns to step S34).

If content can be transmitted to a client machine that is on (Yes in step S35), the server device 1 registers the client machine 2 that has been turned on in the client registration unit 122 as a client machine to which content can be transmitted (step S36). Note that a machine to which content can be transmitted refers to a machine equipped with devices (display unit, audio output unit, etc.) configured to play back movies constituting the content. In addition, the determination may also be based on whether or not it is registered with the server device 1.

The server device 1 then pauses its own playback of the content (step S37) and stores the information at the time of the pause (if the content is a movie, for example, the time when paused) in the storage unit 12 (step S38). Furthermore, the server device 1 transmits the content of which playback has been paused to the registered client machine 2 (step S39). At this time, the server device 1 transmits the content such that playback can start on the client machine 2 from the paused location. This content transmission may involve transmitting the content from the paused location and thereafter, for example, or may involve transmitting information at the time of pause together with the entire content. The client machine 2 plays back the transmitted content on the display unit 23 and the audio output unit 24 (step S310).

Moreover, if the server device 1 finds a client machine 2 capable of playing content on the local network 100 (Yes in step S33), it checks whether or not a playback-capable notice has been received from the discovered client machine 2 (step S331). When it confirms the playback-capable notice from the discovered client machine 2 (Yes in step S331), the server device 1 registers the discovered client machine 2 in the client registration unit 122 (step S36). Thereafter, the procedure advances to step S37, the playing content is halted, and the content is transmitted to the client machine 2.

If the server device 1 cannot confirm receipt of a playback-capable notice from the discovered client machine 2 (No in step S331), then it searches whether or not another client machine 2 is connected to the local network 100 (returns to step S32).

With the above procedure, content that is being played on the server device 1 is made to be played back on a client machine 2. In the example, playback on the client machine 2 was performed from the position at which playback was paused on the server device 1, but playback may also start from the beginning. For instance, in cases where the operator moves into the service area of the local network 100 while playing content on the server device 1, such as when returning home while playing content on the server device 1, the content playback is switched seamlessly from the server device 1 to the client machine 2.

Note that the server device 1 is configured such that when content is played back on the client machine 2, playback halts (terminates) on the server device 1, but the same content playing on the client machine 2 may also be played back on the server device 1. In addition, playback on the server device 1 and the client machine 2 may be performed in different chronological order. If this is done, in cases where content is displayed on a client machine 2 to perform a presentation, for example, the next image is displayed on the server device 1, which makes it possible to perform the presentation while checking the content that is coming next, thus allowing for a smooth description. Furthermore, it is also possible to have the operator confirm content transmission.

### Fourth Preferred Embodiment

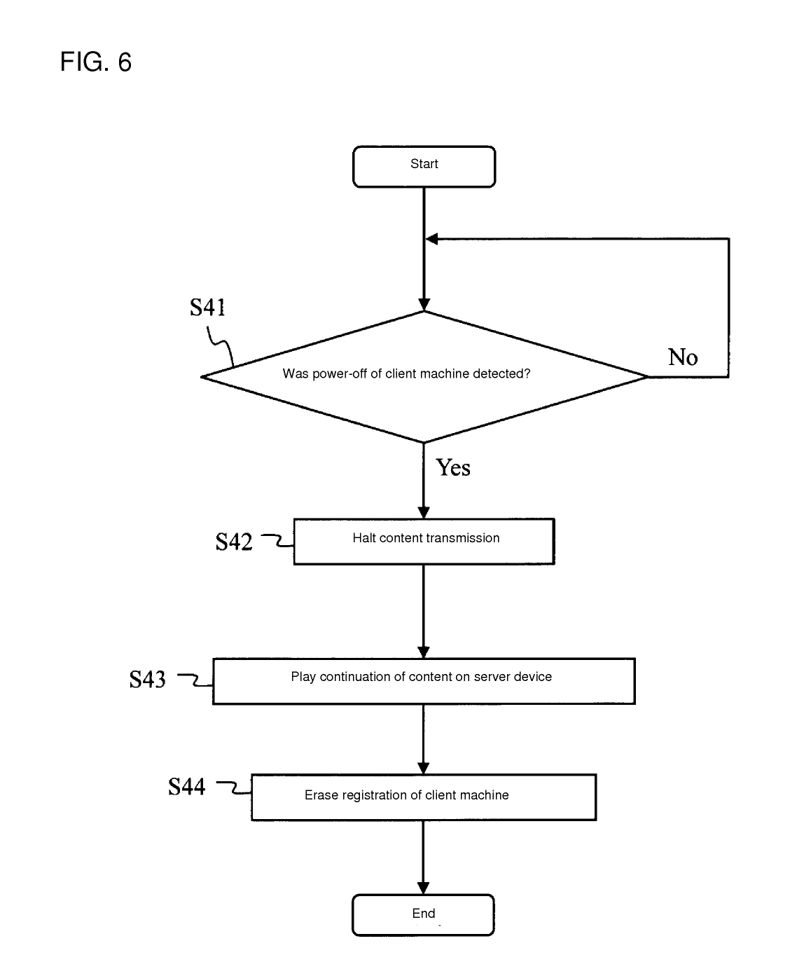

Still another example of playback, on a client machine, of content held on the server device according to another preferred embodiment of the present invention will be described with reference to figures. FIG. 6 is a flowchart showing still another example of a procedure in which content held on the server device is played on a client machine. Note that the server device and the client machine are the same as the ones shown in FIG. 2, so detailed descriptions will be omitted, and the explanation will be given with the same symbols being assigned to elements that are essentially the same.

While content is being played back on the client machine 2, the power supply to the client machine 2 is checked to see if it is off (step S41). When power to the client machine 2 is turned off (Yes in step S41), this client machine 2 disappears from the local network 100. When the server device 1 confirms that the client machine 2 has disappeared from the local network 100 (Yes in step S41), it halts content transmission (step S42) and plays back the continuation on the server device 1 (step S43). Moreover, the server device 1 erases the client machine 2 that disappeared from the local network 100 from the client registration unit 122 (step S44).

Normally, when content is transmitted from the server device 1 to the client machine 2 through the local network 100, a buffering process may be performed which stores content that will be played in future in the storage unit (not shown) of the client machine 2. When the server device 1 plays content that is being transmitted starting from mid-stream while the buffering process is underway, content that was stored in the storage unit of the client machine 2 may not be played back if power to the client machine 2 is turned off. For this reason, the server device 1 is designed so as to play content that includes the buffered content of the client machine 2. The server device 1 may acquire buffering capacity from the client machine 2 or play back after rewinding a predetermined length.

By having a playback procedure such as that described above, an operator who is watching content that is played back on the client machine 2 is able to play back content without being cut off in the middle, even when moving. In addition, by combining this with the playback procedure of the third preferred embodiment, playback of content that is being played on the server device 1 is switched to the client machine 2 at the destination when moving to another room or the like.

Note that, in each of the preferred embodiments, a movie was given as the example of content, but the content is not limited to this, and it may also be photos (still pictures), music, or the like. Furthermore, this sort of device that can reproduce photos (such as a digital camera) or mobile music player can also be used as a server device. Moreover, the client machines are not limited to televisions, either; a wide variety of machines that are able to play back content may be used.

For instance, if the content is sound only (music or the like), a device configured to display images is unnecessary, so a music player or the like can be the client machine. In addition, in the case of configuration in which a connection to a local network can be made with a speaker alone, the speaker can be used as a client machine (renderer).

Furthermore, in each of the preferred embodiments, the client machine to which content was transmitted simultaneously from the server device 1 preferably was a single machine, but client machines are not limited to a single machine; a plurality of client machines may also be used. For example, in cases where a lecture is conducted in which each individual is using a tablet PC, if content is broadcasted from the server device 1, the content can be played simultaneously on all of the tablet PCs (client machines) in the classroom, so the lecture is presented efficiently.

Note that, in each of the preferred embodiments, both the server device and client machines were preferably connected to a local network using wireless circuits, but the present invention is not limited to this. For example, it is also possible to use a network in which at least either the server device or client machines are connected by a wired circuit.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A server device which plays back, on a client machine connected to a same local network, content stored in the server device, wherein the server device comprises:
an operation input unit configured to accept input from an operator; and
a controller configured and programmed to register, when a playback-capable notice notifying that content is capable of being played back on the client machine is acquired from the client machine, the client machine that sent the playback-capable notice as a content transmission destination in a storage unit and then transmit content to the registered client machine.

2. The server device according to claim 1, wherein the controller is configured and programmed to register the client machine that transmitted the playback-capable notice as a content transmission destination only when the operator has enabled the client machine that transmitted the playback-capable notice.

3. The server device according to claim 1, wherein the controller is configured and programmed to search for the client machine to which content is to be transmitted when the operator selects content through the operation input unit.

4. The server device according to claim 1, wherein the controller is configured and programmed to transmit content to the client machine when enabling operating input occurs at the operation input unit.

5. The server device according to claim 1, wherein a playback unit is provided and configured to play the content; and
the controller is configured and programmed to pause the content being played if the playback-capable notice is acquired while the content is being played and also to transmit a portion after a paused portion of the content that was being played to the registered client machine only when there is the registered client machine.

6. The server device according to claim 1, wherein when halt information that halts playback of the content is acquired from the registered client machine, the controller is configured and programmed to erase the client machine registration and also stop content transmission.

7. The server device according to claim 5, wherein when halt information that halts playback of the content is acquired from the registered client machine, the controller is configured and programmed to erase the client machine registration and also stop content transmission.

8. The server device according to claim 7, wherein when the halt information is acquired, the controller is configured and programmed to play back continuation of the content on the playback unit from a stopped position.

9. The server device according to claim 6, wherein a halted state of content transmission is maintained until machine information from a client machine that can play the content is transmitted.

10. The server device according to claim 1, wherein the client machine is one of a computer and a television.

11. The server device according to claim 1, wherein the server device is a smart phone.

12. The server device according to claim 1, wherein the local network is a wireless network.

13. The server device according to claim 5, wherein the playback unit includes a display unit and an audio output unit.

14. The server device according to claim 1, wherein the controller includes a processing circuit configured to process signals and information, and including logic circuitry configured to control the server device.

15. The server device according to claim 1, wherein the playback-capable notice is sent from the client machine to the controller as soon as the power to the client machine is turned on.

16. The server device according to claim 1, wherein the content includes at least one of video, music, and photos.

17. A client machine connected to a local network and capable of playing content, the client machine comprising:
an information transmission unit configured to transmit the playback-capable notice to the server device according to claim 1.

18. The client machine according to claim 17, wherein the information transmission unit is configured to transmit the playback-capable notice as soon as the power to the client machine is turned on.

19. A non-transitory computer-readable medium including a computer program for performing, when the computer program runs on a computer, a method comprising:
registering a client machine connected to a same local network when a playback-capable notice notifying that content stored on a server device is capable of being played back on the client machine is acquired from the client machine;
registering the client machine that sent the playback-capable notice as a content transmission destination; and
transmitting the content to the registered client machine so that the client machine plays back the content.
